(19) United States
(12) Patent Application Publication
(10) Pub. No.: US 2024/0002718 A1
(43) Pub. Date: Jan. 4, 2024

(54) TREATMENT CHEMICAL CARTRIDGES AND METHODS OF USING THE SAME

(71) Applicant: ChampionX USA Inc., Sugar Land, TX (US)

(72) Inventor: Jeremy MOLONEY, Katy, TX (US)

(73) Assignee: ChampionX USA Inc., Sugar Land, TX (US)

(21) Appl. No.: 18/343,269

(22) Filed: Jun. 28, 2023

Related U.S. Application Data
(60) Provisional application No. 63/356,818, filed on Jun. 29, 2022.

(51) Int. Cl. C09K 8/54; E21B 37/06

(52) U.S. Cl. CPC C09K 8/54; E21B 37/06; C09K 2208/32

(57) ABSTRACT

The present disclosure provides systems, cartridges, and methods for treating industrial systems. A system may include a sorbent material disposed in a cartridge, wherein the sorbent material includes a treatment chemical. The system may also include a casing having a side-stream conduit, wherein the cartridge is arranged between an inlet and an outlet of the side-stream conduit. Methods disclosed herein include a method of treating a fluid of an industrial system including adding a liquid treatment chemical to a sorbent material, disposing the sorbent material in a cartridge, passing a fluid through the cartridge, transferring the treatment chemical from the sorbent material to the fluid, and transporting the treatment chemical to the industrial system.

### TECHNICAL FIELD

The present disclosure generally relates to treatment chemical cartridges and methods of using the cartridges in, for example, oil and gas production wells and/or pipelines.

### BACKGROUND

Treatment chemicals, such as corrosion inhibitors, are frequently introduced into oil and gas fluids to aid in maintaining infrastructure integrity. Corrosion inhibitors are added to a wide array of systems and system components, such as cooling systems, refinery units, pipelines, steam generators, and oil or gas producing and production water handling equipment. These corrosion inhibitors are geared towards combating a large variety of corrosion types. For example, a common type of corrosion encountered in well bores is acid induced corrosion where the degree of corrosion depends on a multitude of factors. These factors include, for example, the corrosiveness of the fluid, pipeline metallurgy, temperature, time of corrosive fluid contact time, and pressure.

Typically, oilfield corrosion inhibitor products are injected in a liquid form into a production well or pipeline to help mitigate carbon steel assets from corroding. This relies upon there being the required infrastructure, such as chemical tanks, skids, pumps, and the like. However, for production facilities and pipelines without such infrastructure, the application of usual liquid corrosion inhibitors is more challenging. The primary options available to an operator are to either not to treat the facility or to spend significant resources to enable the application of liquid products.

### BRIEF SUMMARY

In some embodiments, the present disclosure provides a method of treating a subterranean formation. The method comprises adding a liquid treatment chemical, such as a corrosion inhibitor composition, to a sorbent material, disposing the sorbent material in a cartridge, arranging the cartridge at a wellbore of the subterranean formation, passing a fluid through the cartridge, transferring the treatment chemical from the sorbent material to the fluid, and transporting the treatment chemical inhibitor to the metal surface.

The present disclosure also provides a system comprising a sorbent material disposed in a cartridge, wherein the sorbent material comprises a treatment chemical, such as a corrosion inhibitor composition, and a casing comprising a side-stream conduit, wherein the cartridge is arranged between an inlet and an outlet of the side-stream conduit.

Further, the present disclosure provides a method of inhibiting corrosion of a metal surface comprising adding a liquid corrosion inhibitor composition to a sorbent material, disposing the sorbent material in a cartridge, passing a fluid through the cartridge, transferring the corrosion inhibitor from the sorbent material to the fluid, and transporting the corrosion inhibitor to the metal surface.

The foregoing has outlined rather broadly the features and technical advantages of the present disclosure in order that the detailed description that follows may be better understood. Additional features and advantages of the disclosure will be described hereinafter that form the subject of the claims of this application. It should be appreciated by those skilled in the art that the conception and the specific embodiments disclosed may be readily utilized as a basis for modifying or designing other embodiments for carrying out the same purposes of the present disclosure. It should also be realized by those skilled in the art that such equivalent embodiments do not depart from the spirit and scope of the disclosure as set forth in the appended claims.

### BRIEF DESCRIPTION OF THE SEVERAL VIEWS OF THE DRAWINGS

A detailed description of the invention is hereafter described with specific reference being made to the drawings.

FIG. 1 depicts an embodiment of a system incorporating a cartridge of the present disclosure.

FIG. 2 depicts an alternate embodiment of a system incorporating a cartridge of the present disclosure.

### DETAILED DESCRIPTION

The present disclosure provides compositions, systems, cartridges, and methods that can be used in industrial aqueous systems. In some embodiments, a solid absorbent/adsorbent material is saturated with a liquid treatment chemical, such as a corrosion inhibitor, an oxygen scavenger, a drag reducing agent, a hydrogen sulfide scavenger, a foamer, an anti-foamer, an emulsifier, a demulsifier, and any combination thereof. After saturation, the solid material is transferred to a cartridge, container, canister, or the like (hereinafter “cartridge”).

The shape/dimensions of the cartridge are not particularly limited and may be selected based upon the intended application, diameter of the side-stream conduit in fluid communication with the cartridge, etc. For example, the cartridge can take the form of a cylinder with an inlet at a first end of the cylinder and an outlet at a second end of the cylinder. Additionally, the cartridge may be in the form of a tank (similar to a swimming pool sand filter). In some embodiments, a pig launcher may be used as the cartridge. Again, the cartridge dimensions are not particularly limited so long as the cartridge has an inlet (such as perforations) for the medium to enter, an outlet (such as perforations) for the medium to exit, and the ability to contain the sorbent material within, for example, by making the diameter of the perforations smaller than the diameter of the sorbent material. Further, the cartridge may be made from any suitable materials, such as a plastic, a metals, etc., and any combination thereof.

The industrial system may comprise a pipeline, for example, carrying the aqueous medium and in some embodiments, the pipeline may comprise a side-stream conduit/pipe. The cartridge may be installed in the side-stream conduit and a relatively small volume of the aqueous medium may travel into the side-stream conduit and through the cartridge. As the aqueous medium passes through the cartridge, the treatment chemical desorbs from the solid material into the aqueous medium, which then rejoins the pipeline and treats downstream infrastructure, such as infrastructure comprising steel.

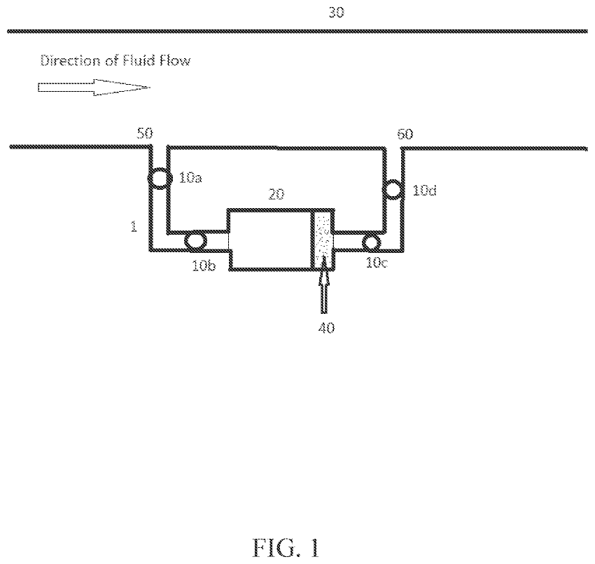

As can be seen in FIG. 1, an industrial pipeline system of the present disclosure may comprise a side-stream conduit (1) having any number of one-way check valves/non-return valves (10a-10d), which allows a relatively small amount of fluid flowing under the force of the produced fluids to pass through the cartridge (20). This allows the treatment chemical, such as a corrosion inhibitor, to enter into the pipeline (30) system without the need for typical chemical injection infrastructure and associated costs of power, pumps, and injection equipment. In some embodiments, the pipeline does not comprise a side-steam conduit and instead, the cartridge is attached to an interior wall of the pipeline. In certain embodiments, the pipeline comprises a side-stream conduit including a cartridge and an additional cartridge is attached to an interior wall of the pipeline.

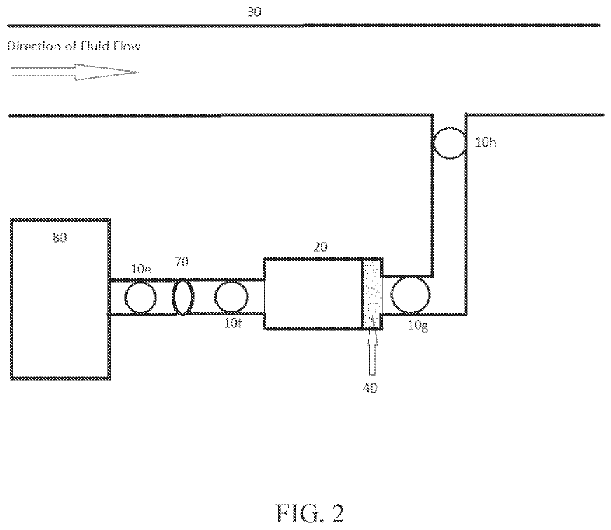

In still a further embodiment (see FIG. 2), a separate fluid source, such as, but not limited to, water, methanol, a solvent, etc., may be housed in a storage tank (80) and transported through the cartridge by using a pump (70). FIG. 2 shows the side-stream conduit having four one-way check valves (10e-10h) but the side-stream conduit may have less than four valves or more than four valves. While FIG. 2 depicts the liquid originating from a storage tank (80), it need not originate from a storage tank and instead may be, for example, fluid pumped from any source separate from the pipeline (30), such as fluid (e.g., water) headed to disposal.

After all of the treatment chemical within the cartridge has been used/transferred into the fluid, one or more of the valves, such as 10a and 10c, 10a and 10d, 10b and 10c, or 10b and 10d may be closed and the cartridge may be removed from the side-stream conduit. The number of one-way check valves is not critical and may be selected by one of skill in the art. In some embodiments, such as in FIG. 1, the side-stream conduit comprises two check valves upstream of the cartridge and two check valves downstream of the cartridge. In other embodiments, for example, there may be a single check valve upstream of the cartridge and a single check valve downstream of the cartridge. The side-stream conduit may comprise any number, such as one, two, three, four, or five, of valves upstream of the cartridge and any number, such as one, two, three, four, or five, of valves downstream of the cartridge.

The solid material may be removed from the cartridge and re-saturated with a treatment chemical. The solid material may then be placed back into the cartridge and the cartridge may be placed back into the side-stream conduit. Once the cartridge in in place, the valve(s) may be opened to allow fluid flow through the cartridge.

In some embodiments, the present disclosure provides a system comprising a sorbent material disposed in a cartridge, wherein the sorbent material comprises a treatment chemical, such as a corrosion inhibitor composition. The system may also comprise a casing/pipeline having a side-stream conduit and the cartridge may be arranged between an inlet (50) and an outlet (60) of the side-stream conduit. In some embodiments, a wellbore comprises the casing. The side-stream conduit may comprise a valve, or any number of valves, before and/or after the cartridge.

In accordance with the present disclosure, the sorbent material may be an absorbent material, an adsorbent material, or any combination thereof. In certain embodiments, the sorbent material is a solid. The sorbent material may comprise, for example, a member selected from the group consisting of a zeolite, activated carbon, aluminum oxide, silica, diatomaceous earth, calcite, dolomite, sand, a nanomaterial, cellulose, and any combination thereof.

In some embodiments, the sorbent excludes an anodic corrosion inhibitor, such as a transition metal salt. Alternatively, or additionally, the sorbent may exclude a cathodic corrosion inhibitor, such as a rare earth metal. Further, the sorbent may exclude a gelling agent and/or a metal complexing agent, such as a water-soluble organic acid salt.

The sorbent material may comprise a variety of treatment chemicals, compounds, and/or compositions.

Examples of liquid treatment chemicals include, but are not limited to, an organic sulfur compound, an imidazoline, a carboxylic acid, a fatty acid amine condensate, a substituted fatty acid ester, a substituted aromatic amine, a phosphoric acid ester, a quaternary ammonium compound, or a compound comprising multiple positive charges.

The compound comprising multiple positive charges may be derived from a polyamine through its reactions with an activated olefin and an epoxide, wherein the activated olefin has the following formula:

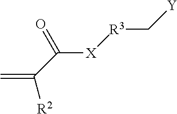

wherein X is NH or O; R² is H, CH₃, or an unsubstituted, linear or branched C₂-C₁₀ alkyl, alkenyl, or alkynyl group; R³ is absent or an unsubstituted, linear C₁-C₃₀ alkylene group; Y is —NR₄R₅R₆⁽⁺⁾; R⁴, R⁵, and R⁶ are independently a C₁-C₁₀ alkyl group; wherein the epoxide has the following formula;

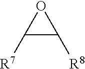

R⁷ is H or alkyl; and Fe is alkyl, or —(CH₂)ₖ-O-alkyl, wherein k is an integer of 1-30; wherein the polyamine and activated olefin undergo aza Michael Addition reaction and the polyamine and epoxide undergo ring opening reaction. In some embodiments, the compound comprises a nonionic group.

In some embodiments, the compound has one of the generic formula of NA₂-[R^{10′}]ₙ—NA₂, (RNA)ₙ—RNA₂, NA2-(RNA)n-RNA2, or NA₂-(RN(R′))ₙ—RNA₂, wherein R^{10′} is a linear or branched, unsubstituted or substituted C₂-C₁₀ alkylene group, or combination thereof; R is —CH₂—, —CH₂CH₂—, —CH₂CH₂CH₂—, —CH(CH₃)CH₂—, a linear or branched, unsubstituted or substituted C₄-C₁₀ alkylene group, or combination thereof; R′ is —CH₂—, —CH₂CH₂—, —CH₂CH₂CH₂—, —CH(CH₃)CH₂—, a linear or branched, unsubstituted or substituted C₄-C₁₀ alkyl group, RNAB, RNARNAB, or RN(RNAB)₂; n can be from 2 to 1,000,000; A is a combination of H,

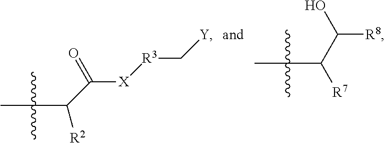

wherein X is NH or O; R² is H, CH₃, or an unsubstituted, linear or branched C₂-C₁₀ alkyl, alkenyl, or alkynyl group; R³ is absent or an unsubstituted, linear C₁-C₃₀ alkylene group; Y is —NR₄R₅R₆⁽⁺⁾; R⁴, R⁵, and R⁶ are independently a C₁-C₁₀ alkyl group; R⁷ is H or alkyl; and Fe is alkyl, or —(CH₂)ₖ-O-alkyl, wherein k is an integer of 1-30.

The compound may be a multiple charged cationic compound having a

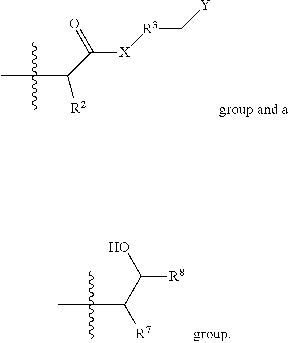

In some aspects, the liquid treatment chemical is oil-soluble.

In some aspects, the liquid treatment chemical can be 2-mercaptoethanol, a diethylenetriamine (DETA): tall oil fatty acid (TOFA) imidazoline, a reaction product of trimethylamine (TEA) and TOFA, a reaction product of TOFA and tetraethylenepentamine (TEPA), an alkyl pyridine, an ethoxylated branched nonylphenol phosphate ester, a benzy-(C₁₂ to C₁₈ linear alkyl)-dimethylammonium chloride, 5-carboxy-4-hexyl-2-cyclohexene octanoic acid, 6-carboxy-4-hexyl-2-cyclohexene octanoic acid, maleated TOFA, an acrylated DETA:TOFA imidazoline, and any combination thereof.

In some embodiments, the liquid treatment chemical is a corrosion inhibitor and the sorbent material comprises the corrosion inhibitor. The corrosion inhibitor may be selected from, for example, benzyl ammonium chloride, acrylated imidazoline, 2-mercaptoethanol, a quaternary ammonium compound, a phosphate ester, a substituted aromatic amine, an alkyl pyridine, a fatty acid amine condensate, and any combination thereof.

The presently disclosed cartridge comprising a corrosion inhibitor is useful for inhibiting corrosion of metal surfaces in contact with any type of corrodent in the medium, such as a metal cation, a metal complex, a metal chelate, an organometallic complex, an aluminum ion, an ammonium ion, a barium ion, a chromium ion, a cobalt ion, a cuprous ion, a cupric ion, a calcium ion, a ferrous ion, a ferric ion, a hydrogen ion, a magnesium ion, a manganese ion, a molybdenum ion, a nickel ion, a potassium ion, a sodium ion, a strontium ion, a titanium ion, a uranium ion, a vanadium ion, a zinc ion, a bromide ion, a carbonate ion, a chlorate ion, a chloride ion, a chlorite ion, a dithionate ion, a fluoride ion, a hypochlorite ion, an iodide ion, a nitrate ion, a nitrite ion, an oxide ion, a perchlorate ion, a peroxide ion, a phosphate ion, a phosphite ion, a sulfate ion, a sulfide ion, a sulfite ion, a hydrogen carbonate ion, a hydrogen phosphate ion, a hydrogen phosphite ion, a hydrogen sulfate ion, a hydrogen sulfite ion, an acid, such as carbonic acid, hydrochloric acid, nitric acid, sulfuric acid, nitrous acid, sulfurous acid, a peroxy acid, or phosphoric acid, ammonia, bromine, carbon dioxide, chlorine, chlorine dioxide, fluorine, hydrogen chloride, hydrogen sulfide, iodine, nitrogen dioxide, nitrogen monoxide, oxygen, ozone, sulfur dioxide, hydrogen peroxide, a polysaccharide, a metal oxide, sand, a clay, silicon dioxide, titanium dioxide, mud, an insoluble inorganic and/or organic particulate, an oxidizing agent, a chelating agent, an alcohol, and any combination of the foregoing.

The presently disclosed corrosion inhibitors are useful for inhibiting corrosion of surfaces comprising any metal or combination of metals. In some aspects, the metal surface comprises steel, such as stainless steel or carbon steel. In some aspects, the metal surface comprises iron, aluminum, zinc, chromium, manganese, nickel, tungsten, molybdenum, titanium, vanadium, cobalt, niobium, copper, or any combination thereof. The metal surface may also comprise boron, phosphorus, sulfur, silicon, oxygen, nitrogen, and any combination thereof. In some aspects, a pipe, such as a pipeline, or any component in fluid communication with the pipe comprises the metal surface.

In some embodiments, the sorbent material comprises from about 0 wt. % to about 90 wt. % of the treatment chemical, such as a corrosion inhibitor. For example, the sorbent material may comprise from about 0.05 wt. % to about 80 wt. %, from about 0.05 wt. % to about 70 wt. %, from about 0.05 wt. % to about 60 wt. %, from about 0.05 wt. % to about 50 wt. %, from about 0.05 wt. % to about 40 wt. %, from about 0.05 wt. % to about 30 wt. %, from about 0.05 wt. % to about 20 wt. %, from about 0.05 wt. % to about 10 wt. %, from about 0.05 wt. % to about 1 wt. %, from about 5 wt. % to about 90 wt. %, from about 10 wt. % to about 90 wt. %, from about 20 wt. % to about 90 wt. %, from about 30 wt. % to about 90 wt. %, from about 40 wt. % to about 90 wt. %, from about 50 wt. % to about 90 wt. %, from about 60 wt. % to about 90 wt. %, from about 70 wt. % to about 90 wt. %, or from about 80 wt. % to about 90 wt. % of the treatment chemical.

The treatment chemical and the sorbent material may be mixed at a weight ratio of about 10:1 to about 1:10 sorbent material to treatment chemical. For example, the treatment chemical and the sorbent material may be mixed at a weight ratio of about 8:1 to about 1:8, about 6:1 to about 1:6, about 4:1 to about 1:4, about 2:1 to about 1:2, or about 1:1 sorbent material to treatment chemical.

In accordance with certain aspects of the present disclosure, the treatment chemical may comprise an oxygen scavenger, a drag reducing agent, a hydrogen sulfide scavenger, a foamer, an anti-foamer, an emulsifier, a demulsifier, and any combination thereof.

Any known oxygen scavenger may be used with the presently disclosed technology, such as sodium bisulfite, ammonium bisulfite, and combinations thereof.

Any known drag reducing agent may be used with the presently disclosed technology, such as a polymer composition comprising an oil-in-water emulsion, which comprises an aqueous phase comprising water and an oil phase comprising an oil-soluble polymer, an oil-miscible polymer, or a emulsifiable polymer, and an additive, wherein the additive comprises a polyglycerol, a polyglycerol derivative, a surfactant having a hydrophilic-lipophilic balance (HLB) of equal to or greater than about 8, or a combination thereof.

Any known hydrogen sulfide scavenger may be used with the presently disclosed technology, such as an oxidant, inorganic peroxide, chlorine dioxide, a C₁-C₁₀ aldehyde, formaldehyde, glyoxal, glutaraldehyde, acrolein, methacrolein, a triazine, or any combination thereof.

Any known foamer may be used with the presently disclosed technology, such as an anionic surfactant, a cationic surfactant, a nonionic surfactant, an amphoteric surfactant, a zwitterionic surfactant, a fluoro-surfactant or any combination thereof. The anionic surfactant may comprise, for example, an alkyl carboxylate, an alkyl sarcosinate, an alkyl sulfosuccinate, a sulfosuccinamate, an alkyl phosphate, an alkyl sulfonate, an alkyl sulfate or any combination thereof. The foamer may also comprise an alkyl carboxylate comprising a fatty carboxylate or an alkyl ether carboxylate; or an alkyl sulfosuccinate comprising a monoalkylsulfosuccinate or a dialkylsulfosuccinate; or an alkyl phosphate comprising an alkyl phosphate ester or an ethoxylated alkyl phosphate ester; or an alkyl sulfonate comprising an alkyl aryl sulfonate, an ester sulfonate, an olefin sulfanate, or a paraffin sulfonate; or an ester sulfonate comprising a C₁₂-C₁₈ ester sulfonate; or an olefin sulfonate comprising a C₁₄-C₂₄ alpha olefin sulfonate or a C₁₅-C₁₇ internal olefin sulfonate; or an alkyl sulfate comprising an alcohol sulfate or an alcohol ether sulfate; or an alcohol ether sulfate comprising a C₁₃-C₁₈ alcohol ether sulfate; or a cationic surfactant comprising a quaternary amine or quaternary ammonium salt thereof; or a quaternary amine comprising a monoalkyl quaternary amine, dialkyl quaternary amine, an alkyltrimethyl quaternary ammonium salt, an alkyl dimethyl benzyl quaternary ammonium salt, an imidazolinium salt or any combination thereof; or a monoalkyl quaternary amine comprising cocotrimonium chloride, soyatrimonium chloride, stearyltrimonium chloride, behentrimonium chloride or any combination thereof; or a dialkyl quaternary amine comprising a dialkyl dimethyl quaternary ammonium salt; or a dialkyl dimethyl quaternary ammonium salt comprising dicetyldimethyl ammonium chloride, dicocodimethyl ammonium chloride, distearyldimethyl ammonium chloride or any combination thereof; or a nonionic surfactant comprising an alkoxylate, an amine oxide, a sorbitan ester, a carboxylic compound, a polyalkoxylated glyceride or any combination thereof; or an alkoxylate comprising an alkoxylated alcohol or ether, an alkylphenol alkoxylate, or an alkyl ethoxylate; or an amine oxide comprising an alkyl dimethyl amine oxide, an alkyl-bis (2-hydroxyethyl) amine oxide, an alkyl amidopropyl dimethyl amine oxide, or an alkylamidopropyl-bis(2-hydroxyethyl) amine oxide; or a sorbitan ester comprising a polyalkoxylated sorbitan ester; or a carboxylic compound comprises a carboxylic acid or a carboxylic ether; or an amphoteric surfactant comprising a betaine, a sultaine, an alkylamphoacetate, an amphodiacetate, an alkylamphopropionate, an alkyliminodipropionate, or an amphodipropionate; or a betaine comprising an alkyl betaine, an alkylamido betaine, or a sulfobetaine; or an alkyl betaine comprising alkyl dimethyl betaine; or an alkyamido betaine comprising an alkylamido propyl betaine; or an alkylamido propyl betaine comprising cocoamido propyl betaine, a capryloamidopropyl betaine, or a caprylamidopropyl betaine; or a sulfobetaine comprising N-decyl-N,N-dimethyl-3-ammonio-1-propanesulfonate or dimethyl-(2-hydroxyethyl)-(3-sulfopropyl) ammonium; or a sultaine comprising an alkylamidopropyl hydroxysultane; or an alkylamidopropyl hydroxysultane comprising lauramidopropyl hydroxysultaine; or an amphoacetate comprising an alkylamphoacetate; or a fluoro-surfactant.

Any known emulsifier may be used with the presently disclosed technology, such as salts of carboxylic acids, products of acylation reactions between carboxylic acids or carboxylic anhydrides and amines, and alkyl, acyl and amide derivatives of saccharides (alkyl-saccharide emulsifiers).

Any known demulsifier may be used with the presently disclosed technology, such as demulsifier may include, for example, acrylic acid, a polymer comprising T-butylphenol, an ethylene oxide (EO) polymer, a propylene oxide (PO) polymer, formaldehyde, maleic anhydride, 4-nonylphenol, propenoic acid, a polymer comprising 2,5-furandione, methyloxirane and/or oxirane, and a reaction product of EO, PO, 4-nonylphenol, formaldehyde, maleic anhydride, and acrylic acid.

The systems disclosed herein may include any number of cartridges. For example, the system may include one, two, three, four, five, six, seven, eight, nine, ten, or more cartridges. Each cartridge comprises a treatment chemical and the treatment chemical of each cartridge may be different or the same. In some embodiments, the system includes only one cartridge and excludes any additional cartridges.

Further, the systems disclosed herein may comprise any number of side-stream conduits. For example, a system may comprise one, two, three, four, five, or more side-stream conduits. Each side-stream conduit may comprise one or more cartridges and one or more valves. In some embodiments, a casing comprises one, two, three, four, five, or more side-stream conduits and each conduit comprises one or more cartridges and one or more valves.

Any composition, sorbent material, cartridge, etc., disclosed herein may comprise an additional treatment chemical selected from the group consisting of a hydrate inhibitor, an asphaltene inhibitor, a paraffin inhibitor, a biocide, a scale inhibitor, and any combination thereof.

A hydrate inhibitor may include, for example, a mono-alkyl amide, a di-alkyl amide, an alkyl quaternary ammonium salt, and any combination thereof.

An asphaltene inhibitor may include, for example, an alkylphenol/formaldehyde resin, a polyisobutylene esters, a polyisobutylene imides, a polyalkyl acrylate, and any combination thereof. In some embodiments, the asphaltene inhibitor is selected from aliphatic sulfonic acids; alkyl aryl sulfonic acids; aryl sulfonates; lignosulfonates; alkylphenol/aldehyde resins and similar sulfonated resins; polyolefin esters; polyolefin imides; polyolefin esters with alkyl, alkylenephenyl or alkylenepyridyl functional groups; polyolefin amides; polyolefin amides with alkyl, alkylenephenyl or alkylenepyridyl functional groups; polyolefin imides with alkyl, alkylenephenyl or alkylenepyridyl functional groups; alkenyl/vinyl pyrrolidone copolymers; graft polymers of polyolefins with maleic anhydride or vinyl imidazole; hyperbranched polyester amides; polyalkoxylated asphaltenes, amphoteric fatty acids, salts of alkyl succinates, sorbitan monooleate, and polyisobutylene succinic anhydride.

A paraffin inhibitor may include, for example, a polyalkyl acrylate, an olefin/maleic anhydride polymer, and any combination thereof. In some embodiments, the paraffin inhibitor is selected from paraffin crystal modifiers, and dispersant/crystal modifier combinations. Suitable paraffin crystal modifiers include, but are not limited to, alkyl acrylate copolymers, alkyl acrylate vinylpyridine copolymers, ethylene vinyl acetate copolymers, maleic anhydride ester copolymers, branched polyethylenes, naphthalene, anthracene, rnicrocrystalline wax and/or asphaltenes. Suitable dispersants include, but are not limited to, dodecyl benzene sulfonate, oxyalkylated alkylphenols, and oxyaikylated alkyiphenolic resins.

A biocide may include, for example, chlorine, hypochlorite, Cl₂, bromine, ozone, hydrogen peroxide, peracetic acid, peroxycarboxylic acid, peroxycarboxylic acid composition, peroxysulphate, glutaraldehyde, dibromonitrilopropionamide, isothiazolone, terbutylazine, polymeric biguanide, a quaternary ammonium compound, methylene bisthiocyanate, tetrakis hydroxymethyl phosphonium sulphate, and any combination thereof.

A scale inhibitor may include, for example, a phosphonate, a sulfonate, a phosphate, a phosphate ester, a polymer comprising a phosphonate or phosphonate ester group, a polymeric organic acid, a peroxycarboxylic acid, and any combination thereof. In some embodiments, the scale inhibitor may be selected from a compound comprising an amine and/or a quaternary amine, nitrilotriacetic acid (NTA), ethylenediaminetetraacetic acid (EDTA), DETA phosphonate, and any combination thereof.

In some embodiments, the scale inhibitor is an acid-based scale inhibitor, such as phosphonic acid. In some embodiments, the scale inhibitor comprises an anionic group. The anionic group may comprise, for example, a carboxylate group or a sulfate group. In some embodiments, the scale inhibitor may include a phosphorous atom, a phosphorous-oxygen double bond, and/or a phosphono group.

In some embodiments, the scale inhibitor is selected from the group consisting of hexamethylene diamine tetrakis (methylene phosphonic acid), diethylene triamine tetra (methylene phosphonic acid), diethylene triamine penta (methylene phosphonic acid), polyacrylic acid (PAA), phosphino carboxylic acid (PPCA), diglycol amine phosphonate (DGA phosphonate), 1-hydroxyethylidene 1,1-diphosphonate (HEDP phosphonate), bisaminoethylether phosphonate (BAEE phosphonate), 2-acrylamido-2-methyl-1-propanesulphonic acid (AMPS), and any combination thereof.

In certain embodiments, the scale inhibitor is a polymer comprising an anionic monomer. The anionic monomer may be selected from, for example, acrylic acid, methacrylic acid, vinyl sulfonic acid, vinyl phosphonic acid, maleic anhydride, itaconic acid, crotonic acid, maleic acid, fumaric acid, styrene sulfonic acid, and any combination thereof.

In some embodiments, the cartridge disclosed herein may comprise an additional treatment chemical selected from a fouling control agent, a corrosion inhibitor intensifier, a preservative, an acid, a surfactant, a pH modifier, an emulsion breaker, a reverse emulsion breaker, a coagulant/flocculant agent, a water clarifier, a dispersant, an antioxidant, a polymer degradation prevention agent, a permeability modifier, a CO₂ scavenger, a gelling agent, a lubricant, a friction reducing agent, a salt, a clay stabilizer, a bactericide, a salt substitute, a relative permeability modifier, a breaker, a fluid loss control additive, a chelating agent, an iron control agent, a flow improver, a viscosity reducer, a solvent, and any combination thereof.

The fouling control agent may comprise, for example, a quaternary compound.

The solvent may comprise, for example, an alcohol, such as methanol, ethanol, propanol, a hydrocarbon, a ketone, an ether, an alkylene glycol, a glycol ether, an amide, a nitrile, a sulfoxide, an ester, and water. For example, the solvent may be water, isopropanol, methanol, ethanol, 2-ethylhexanol, heavy aromatic naphtha, toluene, ethylene glycol, ethylene glycol monobutyl ether (EGMBE), diethylene glycol monoethyl ether, xylene, or any combination thereof.

The acid may comprise, for example, hydrochloric acid, hydrofluoric acid, citric acid, formic acid, acetic acid, or any combination thereof.

The sorbent material may comprise, for example, from about 0 wt. % to about 90 wt. % of the additional treatment chemical. In some embodiments, the sorbent material comprises from about 0.05 wt. % to about 80 wt. %, from about 0.05 wt. % to about 70 wt. %, from about 0.05 wt. % to about 60 wt. %, from about 0.05 wt. % to about 50 wt. %, from about 0.05 wt. % to about 40 wt. %, from about 0.05 wt. % to about 30 wt. %, from about 0.05 wt. % to about 20 wt. %, from about 0.05 wt. % to about 10 wt. %, from about 0.05 wt. % to about 1 wt. %, from about 5 wt. % to about 90 wt. %, from about 10 wt. % to about 90 wt. %, from about 20 wt. % to about 90 wt. %, from about 30 wt. % to about 90 wt. %, from about 40 wt. % to about 90 wt. %, from about 50 wt. % to about 90 wt. %, from about 60 wt. % to about 90 wt. %, from about 70 wt. % to about 90 wt. %, or from about 80 wt. % to about 90 wt. % of the additional treatment chemical. In some embodiments, the sorbent material comprises the additional treatment chemical instead of the treatment/liquid treatment chemical.

The additional treatment chemical and the sorbent material may be mixed at a weight ratio of about 10:1 to about 1:10 sorbent material to additional treatment chemical. For example, the additional treatment chemical and the sorbent material may be mixed at a weight ratio of about 8:1 to about 1:8, about 6:1 to about 1:6, about 4:1 to about 1:4, about 2:1 to about 1:2, or about 1:1 sorbent material to additional treatment chemical.

In some embodiments, the cartridge comprises, consists of, or consists essentially of a sorbent material and a treatment chemical, such as a corrosion inhibitor. In some embodiments, the cartridge comprises, consists of, or consists essentially of a sorbent material, a treatment chemical, such as a corrosion inhibitor, and an additional treatment chemical.

The present disclosure also provides a method of inhibiting corrosion of a metal surface in a subterranean formation. The method comprises adding a liquid corrosion inhibitor composition to a sorbent material. An additional treatment chemical may optionally be added as well. The sorbent material may be allowed to dry, such as by heating the material, and added to the cartridge or the sorbent material may be added to the cartridge without drying or with partial drying.

The liquid corrosion inhibitor and the sorbent material may be mixed at a weight ratio of about 10:1 to about 1:10 sorbent material to liquid corrosion inhibitor. For example, the liquid corrosion inhibitor and the sorbent material may be mixed at a weight ratio of about 8:1 to about 1:8, about 6:1 to about 1:6, about 4:1 to about 1:4, about 2:1 to about 1:2, or about 1:1 sorbent material to liquid corrosion inhibitor.

The cartridge may be arranged at a wellbore of the subterranean formation. For example, the wellbore may comprise a casing and the casing may comprise a side-stream conduit. The casing and/or side-stream conduit may comprise a metal. As fluid passes through the casing, a portion of the fluid will travel through the side-stream conduit and thereby through the cartridge. The cartridge may be arranged, for example, between an inlet and an outlet of the side-stream conduit. The corrosion inhibitor may be transferred from the sorbent material to the fluid as it passes through the cartridge. The fluid then passes through the outlet of the side-stream conduit and rejoins the main body of fluid passing through the casing. The fluid comprising the corrosion inhibitor may then treat any metal surface downstream of the outlet of the side-stream conduit.

In certain embodiments, as shown in FIG. 1, the cartridge comprises a filter (40). The filter has multiple functions, such as preventing the sorbent material from leaving the filter and entering the main fluid stream.

In accordance with the methods disclosed herein, the effective amount of the treatment chemical and/or additional treatment chemical added to the medium of the system, such as the fluid or aqueous medium, is from about 1 ppm to about 10,000 ppm. For example, the effective amount may be from about 1 ppm to about 9,000 ppm, from about 1 ppm to about 8,000 ppm, from about 1 ppm to about 7,000 ppm, from about 1 ppm to about 6,000 ppm, from about 1 ppm to about 5,000 ppm, from about 1 ppm to about 4,000 ppm, from about 1 ppm to about 3,000 ppm, from about 1 ppm to about 2,000 ppm, from about 1 ppm to about 1,000 ppm, from about 1 ppm to about 500 ppm, from about 1 ppm to about 250 ppm, or from about 1 ppm to about 100 ppm. In some embodiments, the effective amount is from about 5 ppm to about 2,000 ppm.

The compositions, cartridges, and methods disclosed herein may be useful for carrying out various processes in an oil & gas operation but the compositions, cartridges, and methods may be used in processes from other industries, such as water treatment, water transmission, agricultural, geothermal, nuclear, etc.

### EXAMPLES

### Example 1

To demonstrate on a laboratory scale, two blends of corrosion inhibitors were mixed and then added to various sorbent materials to saturation before being dried in an oven to remove solvent. The solvent used for the quaternary ammonium compound was methanol and the solvent used for the acrylated imidazoline was isopropyl alcohol. The resulting material was then transferred to a condenser tube with a filter through which brine was poured. Subsequently, an aliquot of this corrosion inhibitor-treated brine was dosed at a concentration of about 1,000 ppm (based on water phase) in corrosion tests.

Blend 1 included benzyl ammonium chloride (about 92% active), acrylated imidazoline (about 80% active), and 2-mercaptoethanol (about 100% active). The approximate ratio of the blend was about 1:1:0.2 benzyl ammonium chloride:acrylated imidazoline:2-mercaptoethanol.

Blend 2 included ethoxylated phenol phosphate ester (about 100% active), alkyl pyridines (about 100% active), and 2-mercaptoethanol (about 100% active). The approximate ratio of the blend was about 1:1:0.2 ethoxylated phenol phosphate ester:alkyl pyridines:2-mercaptoethanol.

The following sorbent materials were used:
1. Sand (Sigma Aldrich, Cat. No. 27439-1 kg, 50-70 mesh particle size (about 210-297 micron particle size)).
2. Zeolite (Sigma Aldrich, Cat. No. 96096-100 g, less than 20 micron particle size).
3. Activated charcoal (Sigma Aldrich, Cat. No. 161551-175 g, 100 mesh particle size (about 149 micron particle size)).
4. Aluminum oxide (Sigma Aldrich, Cat. No. 265497-500 g, less than or equal to about 10 micron particle size).

Various masses of sorbent material and corrosion inhibitor as identified in Table 1 were mixed together and then placed in an oven at about 60° C. for about 17 hours.

TABLE 1

| | | | | | | Weight Ratio |
|---|---|---|---|---|---|---|
| | | Sorbent | | Corrosion | Corrosion | Sorbent |
| | | Material | Corrosion | Inhibitor | Inhibitor Blend | Material: |
| | Sorbent | Mass | Inhibitor | Mass | Generic | Corrosion |
| | Material | Used | Blend | Used | Chemistry | Inhibitor |
| MIX | Sand | About 55 | Blend 1 | About 12 | Quaternary | About |
| 1 | | grams | | grams | ammonium | 4.6:1 |
| | | | | | compound/fatty | |
| | | | | | acid amine | |
| | | | | | condensate/ | |
| | | | | | mercaptoethanol | |
| | | | | | (1:1:0.2) | |
| MIX | Zeolite | About 25 | Blend 1 | About 15 | Quaternary | About |
| 2 | | grams | | grams | ammonium | 1.7:1 |
| | | | | | compound/fatty | |
| | | | | | acid amine | |
| | | | | | condensate/ | |
| | | | | | mercaptoethanol | |
| | | | | | (1:1:0.2) | |
| MIX | Activated | About 8 | Blend 1 | About 15 | Quaternary | About |
| 3 | Charcoal | grams | | grams | ammonium | 0.5:1 |
| | | | | | compound/fatty | |
| | | | | | acid amine | |
| | | | | | condensate/ | |
| | | | | | mercaptoethanol | |
| | | | | | (1:1:0.2) | |
| MIX | Sand | About 55 | Blend 2 | About 12 | Substituted | About |
| 4 | | grams | | grams | aromatic amine/ | 4.6:1 |
| | | | | | phosphate ester/ | |
| | | | | | mercaptoethanol | |
| | | | | | (1:1:0.2) | |
| MIX | Zeolite | About 25 | Blend 2 | About 15 | Substituted | About |
| 5 | | grams | | grams | aromatic amine/ | 1.7:1 |
| | | | | | phosphate ester/ | |
| | | | | | mercaptoethanol | |
| | | | | | (1:1:0.2) | |
| MIX | Activated | About 8 | Blend 2 | About 15 | Substituted | About |
| 6 | Charcoal | grams | | grams | aromatic amine/ | 0.5:1 |
| | | | | | phosphate ester/ | |
| | | | | | mercaptoethanol | |
| | | | | | (1:1:0.2) | |
| MIX | Aluminum | About 50 | Blend 2 | About 10 | Substituted | About 5:1 |
| 7 | Oxide | grams | | grams | aromatic amine/ | |
| | | | | | phosphate ester/ | |
| | | | | | mercaptoethanol | |
| | | | | | (1:1:0.2) | |

About 5 grams of each “MIX” was placed into a glass condenser tube with a filter (Whatman #2 filter paper with 8 micron pore size) through which about 25 ml of brine (about 3% NaCl—the same brine used in the subsequent corrosion testing) was poured through and kept in a glass vessel. In two of the cases (MIX 2 and MIX 6), a second 25 ml of brine was poured through the same medium and kept in a second glass vessel. In the subsequent corrosion test, an appropriate amount of this corrosion inhibitor/brine was injected to achieve about 1,000 ppm on the water phase.

Corrosion bubble cell tests were performed using the following conditions to evaluate the corrosion inhibition performance of the corrosion inhibitor tablets on a carbon steel electrode (C1018 grade). The corrosion rate was assessed electrochemically using linear polarization resistance (LPR) methodology. Tests were carried out at atmospheric pressure at about 80° C. using CO₂ saturated fluids with about 3% NaCl brine (about 99%) and LVT-200 hydrocarbon (about 1%) with a continuous CO₂ sparge.

About 3 to 4 hours pre-corrosion time (i.e., with no corrosion inhibitor) was carried out before filtered brine from the corrosion inhibitor/sorbent material was injected at about 1,000 ppm based on the water phase. The inhibited corrosion rate at about 15 hours after corrosion inhibitor injection was noted and a percentage inhibition was determined by comparing with the corrosion rate of a blank steel electrode at the same time in the test. The results are shown in Table 2.

TABLE 2

| | | | | Approx. | |
|---|---|---|---|---|---|
| | | | | Corrosion | |
| | | | | Rate After | |
| | | | Dose of | About 15 h | |
| | Brine | | Final | of Corrosion | |
| | Flush | Number | Brine | Inhibitor | Approx. |
| | Volume | of Brine | Flush | Injection | Percent |
| | (ml) | Flushes | (ppm) | (mpy) | Protection |
| BLANK | | | | 470 | |
| MIX 1 | 25 | 1 | 1,000 | 0.7 | 100 |
| MIX 2 | 25 | 1 | 1,000 | 51 | 89 |
| MIX 3 | 25 | 1 | 1,000 | 40 | 91 |
| MIX 4 | 25 | 1 | 1,000 | 1.1 | 100 |
| MIX 5 | 25 | 1 | 1,000 | 1.8 | 100 |
| MIX 6 | 25 | 1 | 1,000 | 6 | 99 |
| MIX 7 | 25 | 1 | 1,000 | 3.2 | 99 |
| MIX 2 | 25 | 2 | 1,000 | 29.3 | 94 |
| MIX 6 | 25 | 2 | 1,000 | 6.4 | 99 |

All of the compositions and methods disclosed and claimed herein can be made and executed without undue experimentation in light of the present disclosure. While this invention may be embodied in many different forms, there are described in detail herein specific preferred embodiments of the invention. The present disclosure is an exemplification of the principles of the invention and is not intended to limit the invention to the particular embodiments illustrated. In addition, unless expressly stated to the contrary, use of the term “a” is intended to include “at least one” or “one or more.” For example, “a corrosion inhibitor” is intended to include “at least one corrosion inhibitor” or “one or more corrosion inhibitors.”

Any ranges given either in absolute terms or in approximate terms are intended to encompass both, and any definitions used herein are intended to be clarifying and not limiting. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all subranges (including all fractional and whole values) subsumed therein.

Any composition disclosed herein may comprise, consist of, or consist essentially of any element, component and/or ingredient disclosed herein or any combination of two or more of the elements, components or ingredients disclosed herein.

Any method disclosed herein may comprise, consist of, or consist essentially of any method step disclosed herein or any combination of two or more of the method steps disclosed herein.

The transitional phrase “comprising,” which is synonymous with “including,” “containing,” or “characterized by,” is inclusive or open-ended and does not exclude additional, un-recited elements, components, ingredients and/or method steps.

The transitional phrase “consisting of” excludes any element, component, ingredient, and/or method step not specified in the claim.

The transitional phrase “consisting essentially of” limits the scope of a claim to the specified elements, components, ingredients and/or steps, as well as those that do not materially affect the basic and novel characteristic(s) of the claimed invention.

Unless specified otherwise, all molecular weights referred to herein are weight average molecular weights and all viscosities were measured at 25° C. with neat (not diluted) polymers.

As used herein, the term “about” refers to the cited value being within the errors arising from the standard deviation found in their respective testing measurements, and if those errors cannot be determined, then “about” may refer to, for example, within 5% of the cited value.

Furthermore, the invention encompasses any and all possible combinations of some or all of the various embodiments described herein. It should also be understood that various changes and modifications to the presently preferred embodiments described herein will be apparent to those skilled in the art. Such changes and modifications can be made without departing from the spirit and scope of the invention and without diminishing its intended advantages. It is therefore intended that such changes and modifications be covered by the appended claims.

What is claimed is:

1. A method of inhibiting corrosion of a metal surface in a subterranean formation, comprising:
adding a liquid corrosion inhibitor composition to a sorbent material,
disposing the sorbent material in a cartridge,
arranging the cartridge at a wellbore of the subterranean formation,
passing a fluid through the cartridge,
transferring the corrosion inhibitor from the sorbent material to the fluid, and
transporting the corrosion inhibitor to the metal surface.

2. The method of claim 1, wherein the wellbore comprises a casing and the casing comprises the metal surface.

3. The method of claim 2, wherein the casing comprises a side-stream conduit and the cartridge is arranged between an inlet and an outlet of the side-stream conduit.

4. The method of claim 3, wherein the side-stream conduit comprises a valve before and/or after the cartridge.

5. The method of claim 1, wherein the cartridge comprises a filter.

6. The method of claim 1, wherein the sorbent material is a solid.

7. The method of claim 1, wherein the sorbent material comprises a member selected from the group consisting of a zeolite, activated carbon, aluminum oxide, silica, diatomaceous earth, calcite, dolomite, sand, a nanomaterial, and any combination thereof.

8. The method of claim 1, wherein the sorbent material comprising the liquid corrosion inhibitor is dried before being disposed in the cartridge.

9. The method of claim 1, wherein the liquid corrosion inhibitor is selected from the group consisting of benzyl ammonium chloride, acrylated imidazoline, 2-mercaptoethanol, a quaternary ammonium compound, a phosphate ester, a substituted aromatic amine, an alkyl pyridine, a fatty acid amine condensate, and any combination thereof.

10. The method of claim 1, wherein the sorbent material comprises from about 0.05 wt. % to about 90 wt. % of the liquid corrosion inhibitor.

11. The method of claim 1, wherein the method excludes an additional cartridge.

12. The method of claim 1, wherein the sorbent excludes an anodic corrosion inhibitor, a cathodic corrosion inhibitor, a gelling agent, and/or a metal complexing agent.

13. A system, comprising:
a sorbent material disposed in a cartridge, wherein the sorbent material comprises a treatment chemical, and
a casing comprising a side-stream conduit, wherein the cartridge is arranged between an inlet and an outlet of the side-stream conduit.

14. The system of claim 13, wherein the side-stream conduit comprises a valve before and/or after the cartridge.

15. The system of claim 13, wherein the sorbent material comprises a member selected from the group consisting of a zeolite, activated carbon, aluminum oxide, silica, diatomaceous earth, calcite, dolomite, sand, a nanomaterial, and any combination thereof.

16. The system of claim 13, wherein the treatment chemical is selected from the group consisting of a corrosion inhibitor, an oxygen scavenger, a drag reducing agent, a hydrogen sulfide scavenger, a foamer, an anti-foamer, an emulsifier, a demulsifier, a hydrate inhibitor, an asphaltene inhibitor, a paraffin inhibitor, a biocide, a scale inhibitor, a fouling control agent, a corrosion inhibitor intensifier, a preservative, an acid, a surfactant, a pH modifier, an emulsion breaker, a reverse emulsion breaker, a coagulant/flocculant agent, a water clarifier, a dispersant, an antioxidant, a polymer degradation prevention agent, a permeability modifier, a CO₂ scavenger, a gelling agent, a lubricant, a friction reducing agent, a salt, a clay stabilizer, a bactericide, a salt substitute, a relative permeability modifier, a breaker, a fluid loss control additive, a chelating agent, an iron control agent, a flow improver, a viscosity reducer, a solvent, and any combination thereof.

17. A method of treating an industrial system, comprising:
adding a liquid treatment chemical to a sorbent material,
disposing the sorbent material in a cartridge,
passing a fluid from the industrial system through the cartridge,
transferring the treatment chemical from the sorbent material to the fluid, and
treating the industrial system.

18. The method of claim 17, wherein a pipeline comprises the fluid.

19. The method of claim 18, wherein the pipeline comprises a side-stream conduit and the cartridge is arranged between an inlet and an outlet of the side-stream conduit.

20. The method of claim 17, wherein the treatment chemical is selected from the group consisting of a corrosion inhibitor, an oxygen scavenger, a drag reducing agent, a hydrogen sulfide scavenger, a foamer, an anti-foamer, an emulsifier, a demulsifier, a hydrate inhibitor, an asphaltene inhibitor, a paraffin inhibitor, a biocide, a scale inhibitor, a fouling control agent, a corrosion inhibitor intensifier, a preservative, an acid, a surfactant, a pH modifier, an emulsion breaker, a reverse emulsion breaker, a coagulant/flocculant agent, a water clarifier, a dispersant, an antioxidant, a polymer degradation prevention agent, a permeability modifier, a CO₂ scavenger, a gelling agent, a lubricant, a friction reducing agent, a salt, a clay stabilizer, a bactericide, a salt substitute, a relative permeability modifier, a breaker, a fluid loss control additive, a chelating agent, an iron control agent, a flow improver, a viscosity reducer, a solvent, and any combination thereof.
